(19) United States
(12) Patent Application Publication
(10) Pub. No.: US 2006/0108400 A1
(43) Pub. Date: May 25, 2006

(54) Soldering method and apparatus

(75) Inventors: Hiroshi Fukaya, Hong Kong (HK); Satoshi Yamaguchi, Hong Kong (HK)

Correspondence Address: GREENBLUM & BERNSTEIN, P.L.C., 1950 ROLAND CLARKE PLACE, RESTON, VA, 20191, US

(73) Assignee: SAE Magnetics (H.K.) Ltd., Hong Kong (HK)

(21) Appl. No.: 11/274,420

(22) Filed: Nov. 16, 2005

(30) Foreign Application Priority Data
Nov. 25, 2004 (JP) 2004-340286

(51) Int. Cl. B23K 31/02; B23K 35/24

(52) U.S. Cl. 228/227; 228/230; 219/121.63

(57) ABSTRACT

It is to provide a soldering method and apparatus, which can achieve highly reliable soldering while suppressing damages to a component to be soldered. There is provided a method for soldering an electronic component to a substrate, which comprises a first heating step for heating the entire solder junction area, and a second heating step for heating a part of the solder junction area, which is distant from the electronic component.

### BACKGROUND OF THE INVENTION

### Field of the Invention

The present invention relates to a soldering method and an apparatus thereof and, more specifically, to a method and an apparatus for soldering electronic components.

Soldering is to perform bonding through heating and melting solder on a solder pad surface where a gold-plated layer is formed, so that the solder and the gold on the solder pad surface are fused to form gold-tin alloy. It is used as a means for bonding electronic components to a substrate and the like, for example. More specifically, as shown in FIG. 1A, in the case of a magnetic head slider 114 which comprises a magnetic head element 115 as an electronic component, soldering is employed when fabricating a magnetic head assembly 101 by soldering the magnetic head slider 114 to a suspension 11 to which a flexible printed circuit 112 is integrated. As a method thereof, solder 117 which bonds a solder pad 113 of the suspension 111 side and a solder pad 116 of the magnetic head slider 114 side is disposed in a form of solder ball (or in a form of paste) at a junction area. Then, as shown in FIG. 1B, laser beam 102a is irradiated from a laser torch 102 for melting the solder to achieve soldering.

However, as described above, in the case where the target of bonding by soldering is an electronic component, the electronic component may be heated up to a high temperature of more than the resistable temperature thereof by the heat applied at the time of soldering. If so, there may generate such a problem that the electronic component may be damaged by the heat of soldering. Thus, conventionally, time for heating the solder using a laser and the like is limited to be short. Further, as disclosed in Japanese Patent Unexamined Publication 2004-260019, there has been investigated a method which measures the heat released from the main body of the electronic component that is the bonding target of soldering, and performs soldering by controlling the heat to be lower than the resistable temperature of the electronic component.

However, there may be following inconveniences generated even in the conventional soldering method described above.

First, when the time for heating the solder is limited to be short, diffusion of gold from the solder pads 113 and 116 to the solder 117 becomes insufficient due to the short heating time. FIG. 2A shows a crystallogram of the solder 117 after performing soldering with a short heating time, and FIG. 2B shows an enlarged picture of an area R11′ that is a part of R11. In these drawings, white needle-shaped substance is the gold-tin alloy. As shown in areas of R11 and R12 in FIG. 2A, the gold-tin alloy is concentratedly formed in the vicinity of the solder pad surfaces 113 and 116. Thus, a gold-tin alloy layer is formed in the vicinity of the solder pad surfaces 113 and 116, and tin alloy is formed in other areas. Therefore, the solder 117 in the junction area is divided to the gold-tin alloy and the tin alloy so that solder cracks are likely to be generated at the boundary surface between each alloy. In addition, since the strength of the tine alloy is weak, solder separation is likely to be caused. As a result, reliability of soldering is decreased.

Further, in the method disclosed in the above-described Patent Document in which the radiant heat of the electronic component is measured, heating to the solder is controlled so that the temperature of the electronic component does not exceed the resistable temperature. Thus, the electronic component can be protected, however, there is no guarantee that heating to the solder is sufficiently carried out. Therefore, like the above-described case, there causes a problem that diffusion of the gold to the entire solder is insufficient and the reliability of soldering is decreased. Furthermore, an apparatus disclosed in the above-described Patent Document requires, in addition to a soldering device, a temperature sensor and a controlling device for controlling heating based on a detected value of the temperature sensor, thereby complicating the structure of the apparatus.

### SUMMARY OF THE INVENTION

An object of the present invention therefore is to improve the shortcomings of the above-described conventional case and, specifically, to provide a soldering method and an apparatus thereof, which can achieve highly reliable soldering while suppressing damages to the soldered components caused by heat.

The soldering method as one form of the present invention is a soldering method for soldering an electronic component to a substrate. The method comprises a re-heating step for heating a solder connected area which is distant from the electronic component. Specifically, the method comprises: a first heating step for heating entire solder junction area; and a second heating step for heating a part of the solder junction area, which is distant from the electronic component.

In the above-described invention, first, pre-melted solder is supplied to the solder junction area for achieving bonding. Alternatively, solder is melted when the entire solder junction area is heated by the first heating so that it enables to achieve bonding uniformly between the solder and solder pads formed on the electronic component and the substrate. At this time, gold on the solder pads of the electronic component and the substrate diffuses on the solder, thereby producing gold-tine alloy in the vicinity of the solder pad surfaces. Subsequently, there is carried out the second heating for heating the area which is especially distant from the electronic component. By this heating, the gold in the gold-tin alloy is uniformly diffused to the entire solder while suppressing excessive heating of the electronic component since the heating area is distant from the electronic component. Accordingly, the entire solder on the junction area can become the gold-tin alloy so that the strength of the solder can be improved. Therefore, it enables to improve the reliability of soldering while enabling to protect the electronic component.

Further, the second heating step is to heat a vicinity of junction area between the solder and the substrate. Thereby, the gold-tine alloy formed in the vicinity of the solder pad surface on the substrate side is heated. Thus, diffusion of the gold to the entire solder can be promoted. At the same time, the gold-tin alloy in the vicinity of the solder pad surface on the electronic component side diffuses by being drawn to the solder pad direction on the substrate side. Thereby, heating of the electronic component can be suppressed and diffusion of the gold over the entire solder can be more uniformly achieved. At this time, specifically, by heating the area that is most distant form the electronic component in the second heating step, heating of the electronic component can be more suppressed so that better protection of the electronic component can be achieved.

Further, the second heating step performs heating so as to apply, to the solder junction area, an amount of heat that is smaller than the first heating step. With this, it enables to suppress excessive amount of heat to be applied to the electronic component and to promote more uniform diffusion of the gold over the entire solder.

Furthermore, the second heating step performs heating for a longer time than the first heating step. Thereby, diffusion of the gold can be more uniformly achieved over the entire solder by the long-time heating. Particularly, in the case where the applied heat amount is smaller than that of the first heating step, it is also possible to suppress excessive amount of heat to be applied to the electronic component even thought it is heated for a long time.

Also, the second heating step performs heating by irradiating a laser beam. At this time, the second heating step performs irradiation in such a manner that the laser beam is not irradiated to the electronic component. In addition, the second heating step sets an irradiation area by shielding a part of the laser beam.

With this, it enables by the laser beam to more locally heat the area that is distant form the electronic component, e.g. the junction area between the substrate and the solder that is most distant from the electronic component. Therefore, it is possible to achieve diffusion of the gold to the entire solder uniformly while suppressing a highly increased temperature of the electronic component. Specifically, by controlling the irradiating position of the laser beam and setting the irradiation area through shielding the laser beam by using the shield member, highly increased temperature of the electronic component can be more suppressed, thereby achieving the protection thereof. Further, it becomes easy to control the irradiation area of the laser beam.

Furthermore, in the second heating step, the electronic component is to be cooled. Thereby, highly increased temperature of the electronic component at the time of soldering can be suppressed. Thus, diffusion of the gold over the solder can be promoted while protecting the electronic component.

Further, in the second heating step, a cooling medium is blown against the electronic component and a shielding member used for shielding a part of the laser beam is disposed so that the cooling medium is guided to the electronic component. With this, the shielding member, while used for shielding the laser beam, can be used for guiding the cooling medium to the electronic component. Therefore, it enables to simplify the structure of the apparatus while increasing the effect of cooling.

As another form of soldering method according to the present invention, there is a soldering method for soldering an electronic component to a substrate, wherein a solder junction area is intermittently heated at least twice or more. First of all, by performing intermittent heating of the solder junction area as described above, excessive heating of the electronic component can be suppressed compared to the case where heating is performed once for a long time. Also, first, the solder is melted in the previous heating, for example, the first heating, so that bonding can be uniformly achieved between the solder and the solder pads formed on the electronic component and the substrate. At the same time, by the intermittent heating performed thereafter, gold on the solder pads almost uniformly diffuses over the entire solder so that the entire solder in the junction area can become gold-tine alloy. Accordingly, the strength of the solder can be improved. Thus, it enables to improve the reliability of soldering and to protect the electronic component. In addition, it is unnecessary to control the heating position of the solder junction area and control the heating output value. Therefore, soldering work can be simplified and sped up.

In the above-described method, particularly, each heating of second time and after is performed for a shorter time than the first heating. Thereby, diffusion of the gold onto the solder is promoted as in the above-described case, thereby enabling to improve the strength of the solder. At the same time, heat applied to the electronic component can be more suppressed so that the electronic component can be protected.

Further, as still another soldering method according to the present invention, there is a soldering method for soldering an electronic component to a substrate, wherein: a solder junction area is intermittently heated at least twice or more; and each heating of second time and after is performed for a shorter time than the first heating. Thereby, like the above-described case, first, the solder is melted in the first heating, so that bonding can be uniformly achieved between the solder and the solder pads formed on the electronic component and the substrate. By weak heating performed in the second time and thereafter, gold can be uniformly diffused over the entire solder in the solder junction area while suppressing excessive heating of the electronic component. Accordingly, the strength of the solder can be improved. Thus, it enables to improve the reliability of soldering and to protect the electronic component. In addition, it is unnecessary to control the heating position of the solder junction area. Therefore, soldering work can be simplified and sped up.

In the above-described method, particularly, heating is performed twice, and the second heating is performed for a longer time than the first heating. Thereby, diffusion of the gold can be more uniformly achieved over the entire solder and the reliability of the soldering can be improved.

Further, the aforementioned electronic component is a magnetic head slider, and the solder junction area is a junction area between the substrate and a connection terminal that is connected to a magnetic head element part of the magnetic head slider.

By the first heating, solder bonding can be performed without having the solder nonuniformly disposed to either the connecting pad of the magnetic head slider or that of the suspension, which are disposed at roughly the right angle. Then, by the second heating, diffusion of the gold is spread over the entire solder as described above, thereby achieving the strong bonding.

Further, as another form of the present invention, there is provided a magnetic head assembly which comprises the magnetic head slider that is bonded to a suspension by the above-described soldering method. In the magnetic head assembly, gold is dispersedly present on the entire solder of the solder junction area. Furthermore, the present invention provides a magnetic disk device to which the above-described magnetic head assembly is mounted. With this, in the manufactured magnetic head assembly and the magnetic disk device, inferiority of the magnetic head slider can be suppressed. Also, since the reliability of the solder bonding is high, the reliability of the product can be improved.

The soldering apparatus as another form of the present invention is a soldering apparatus for soldering an electronic component to a substrate, which comprises a heating unit for re-heating a solder connected area which is distant from the electronic component.

Particularly, the apparatus comprises: a first heating unit for heating the entire solder junction area; and a second heating unit for heating a part of the solder junction area of the electronic component that is heated by the first heating unit, which is distant from the electronic component.

At this time, the first heating unit and the second heating unit are constituted of a same heating unit.

The second heating unit performs heating so as to apply, to the solder junction area, an amount of heat that is smaller than the first heating unit. In addition, the second heating unit performs heating for a longer time than the first heating unit. Further, the soldering apparatus comprises a cooling unit for cooling the electronic component when being heated by the second heating unit.

Furthermore, at least the second heating unit is constituted of a laser irradiating unit which irradiates a laser beam to the solder junction area. At this time, the laser irradiating unit as the second heating unit irradiates the laser beam to an area smaller than the area of the solder junction area, which is heated by the first heating unit.

Also, the soldering apparatus comprises a shielding member for shielding a part of the laser beam which is irradiated from the laser irradiating unit as the second heating unit. At this time, the shielding member comprises a through hole in the solder junction area for letting through a part of the laser beam.

As another form of the soldering apparatus according to the present invention, there is a soldering apparatus for soldering an electronic component to a substrate, which comprises a heating unit that intermittently heats a solder junction area at least twice or more. At this time, the heating unit performs each heating of second time and after for a shorter time than the first heating.

Further, still another form of the soldering apparatus according to the present invention, there is a soldering apparatus for soldering an electronic component to a substrate, which comprises a heating unit for heating a solder junction area at least twice or more, wherein the heating unit performs heating so as to apply an amount of heat that is smaller than the first heating when performing heating of the second time and after. At this time, the heating unit performs the hating twice, and second heating is performed for a longer time than the first heating.

The soldering apparatus constituted in the manner as described above functions like the above-described soldering method. Thus, it is possible to achieve the above-described object of the present invention, which is to achieve highly reliable soldering while protecting the electronic component as the soldering target.

The present invention is constituted and functions as described above. With this, it enables to suppress excessive heating of the electronic component as the target of soldering due to the heat applied to the solder. Thus, the electronic component can be protected. In addition, since the gold-tin alloy diffuses almost uniformly over the entire solder, it is possible to improve the strength of the solder and to improve the reliability of soldering, which is an excellent effect that is not of the conventional case.

### BRIEF DESCRIPTION OF THE DRAWINGS

FIG. 1A is an illustration for describing a soldering apparatus of a conventional case, which specifically shows a soldering target, and FIG. 1B is an illustration for showing the state of soldering;

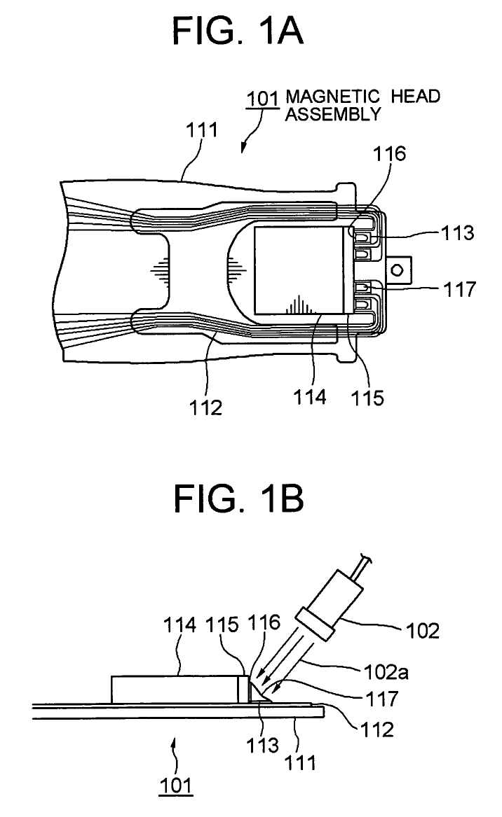

FIG. 2A shows a crystallogram of the solder after performing soldering in the conventional case, and FIG. 2B is a fragmentary enlarged view of FIG. 2A;

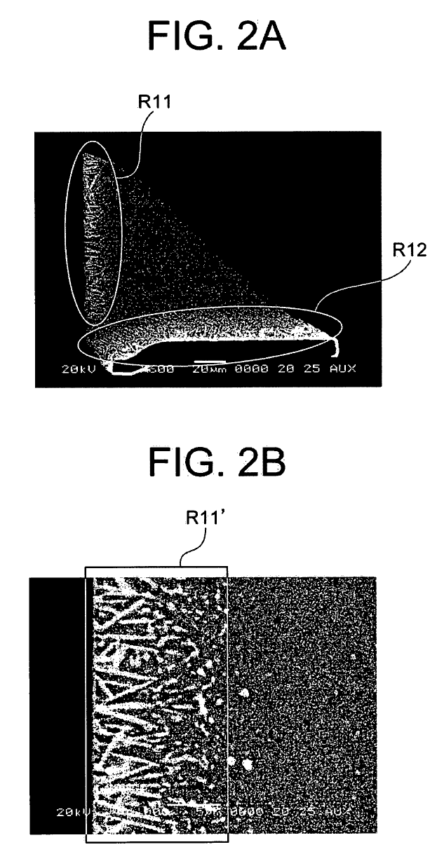

FIGS. 3A and 3B are schematic views for showing the structure of a soldering apparatus according to a first embodiment, in which FIG. 3A shows the state of a first heating step and FIG. 3B shows the state of a second heating step;

FIG. 4 is a flowchart for describing operation of the soldering apparatus according to the first embodiment;

FIGS. 5A and 5B are illustrations for schematically showing the state of solder at the time of heating, in which FIG. 5A shows the state at the time of performing the first heating state, FIG. 5B shows the state at the time of performing the second heating step, and FIG. 5C shows the state where the second heating step is completed;

FIG. 6A is a crystallogram which shows the state of solder after performing soldering, and FIG. 6B is a fragmentary enlarged view of FIG. 6A;

FIGS. 7A and 7B are schematic views for showing a modification example of the structure of the soldering apparatus of the first embodiment, in which FIG. 7A shows the state at the time of performing the first heating step, and FIG. 7B shows the state at the time of performing the second heating step;

FIGS. 8A and 8B are schematic views for showing the structure of a soldering apparatus according to a second embodiment, in which FIG. 8A shows the state at the time of performing the first heating step, and FIG. 8B shows the state at the time of performing the second heating step;

FIG. 9 is a flowchart for describing operation of the soldering apparatus according to the second embodiment;

FIGS. 10A and 10B are schematic views for showing the structure of a soldering apparatus according to a third embodiment, in which FIG. 10A shows the state at the time of performing the first heating step, and FIG. 10B shows the state at the time of performing the second heating step;

FIGS. 11A and 11B are illustrations for describing a heating range of the third embodiment, in which FIG. 11A shows a heating range that is set once by a heating unit in the second heating step, and FIG. 11B shows the actual heating range;

FIG. 12 is a flowchart for describing operation of the soldering apparatus according to the third embodiment;

FIGS. 13A and 13B are schematic views for showing the structure of a soldering apparatus according to a fourth embodiment, in which FIG. 13A shows the state at the time of performing the first heating step, and FIG. 10B shows the state at the time of performing the second heating step;

FIG. 14 is a flowchart for describing operation of the soldering apparatus according to the fourth embodiment;

FIG. 15 is a flowchart for describing operation of a soldering apparatus according to a fifth embodiment;

FIG. 16 is a flowchart for describing operation of a soldering apparatus according to a modification example of the fifth embodiment; and

FIG. 17 is an illustration for showing the structure of a magnetic disk device according to a seventh embodiment.

### DETAILED DESCRIPTION OF THE PREFERRED EMBODIMENTS

The present invention is distinctive in respect that the second heating is carried out at the time of soldering an electronic component. The entire solder junction area is heated in the first time, and a part that is distant from the electronic component is heated in the second time. Thereby, while suppressing damages to the electronic component, gold-tin alloy is diffused over the entire solder thus achieving highly reliable soldering.

Further, in another form of the present invention, when soldering the electronic component, heating is performed for a plurality of times in which the same area of the solder junction area is heated every time while controlling the intensity of heating and the heating time. Thereby, the gold-tin alloy is diffused over the entire solder so that highly reliable soldering can be achieved while suppressing damages to the electronic component.

The following embodiments will be described by referring to the case of bonding a magnetic head slider to a suspension. That is, there is described the case of solder-bonding a solder pad that functions as a connection terminal of the magnetic head slider as the electronic component and a solder pad that functions as a connection terminal of a flexible printed circuit with a wiring trace, which is integrated with a suspension. However, the present invention can be applied to soldering for any types of electronic components.

Also, it has been described above that heating is performed twice. However, in the case where the melted solder that is heated in advance is supplied to the solder junction area, this heating applied to the solder is counted as the first heating.

### First Embodiment

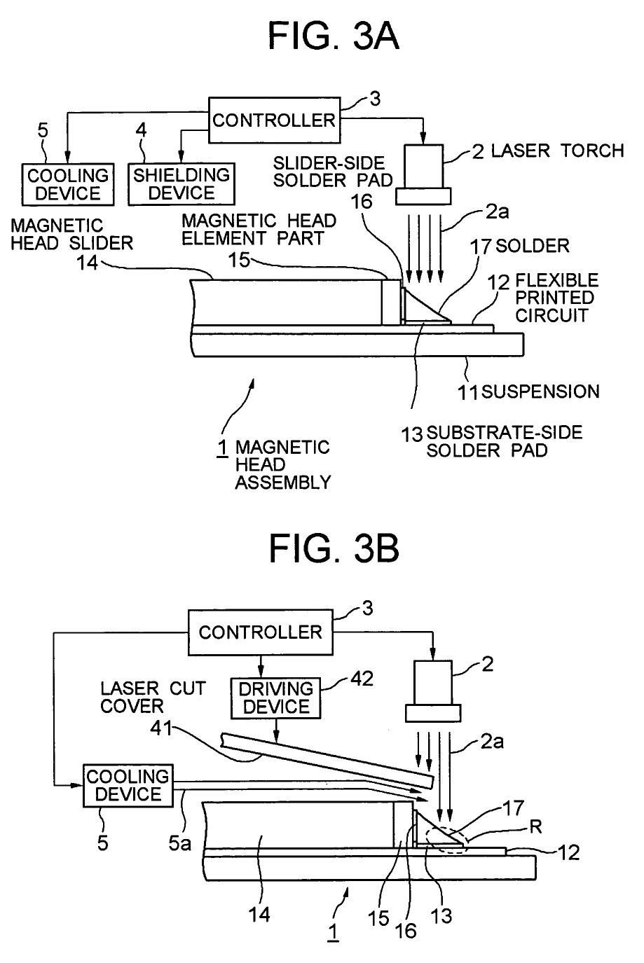

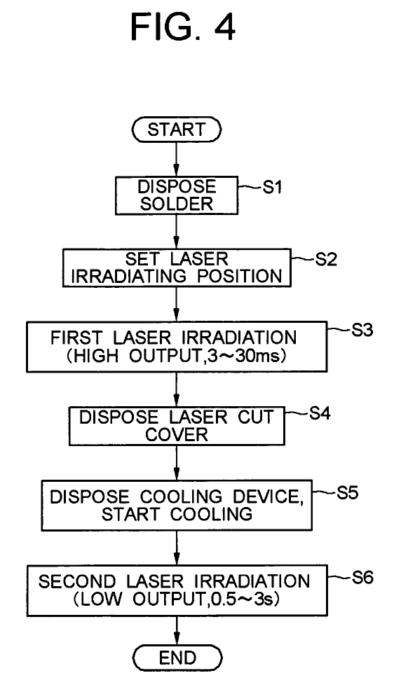

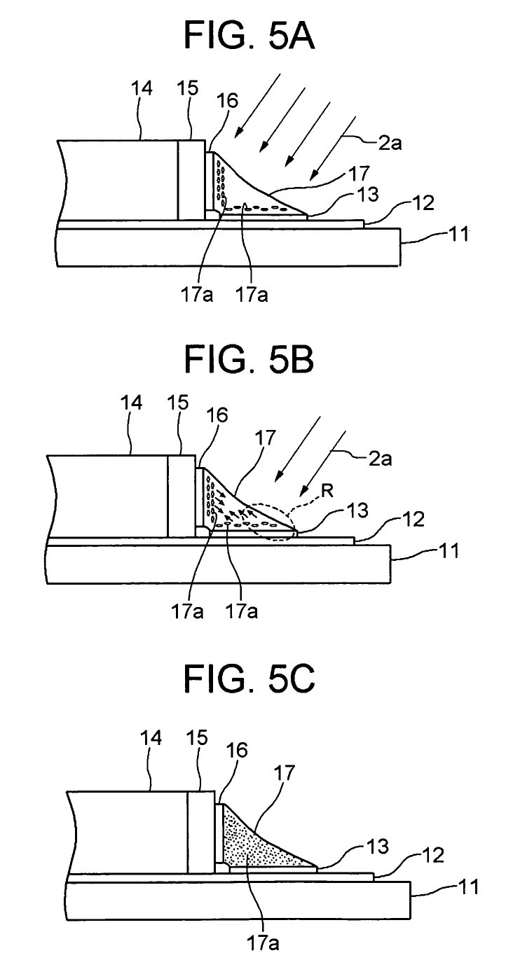

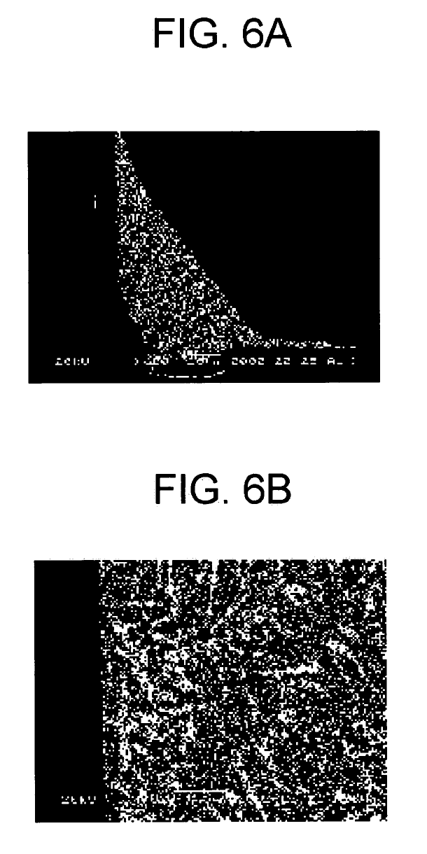

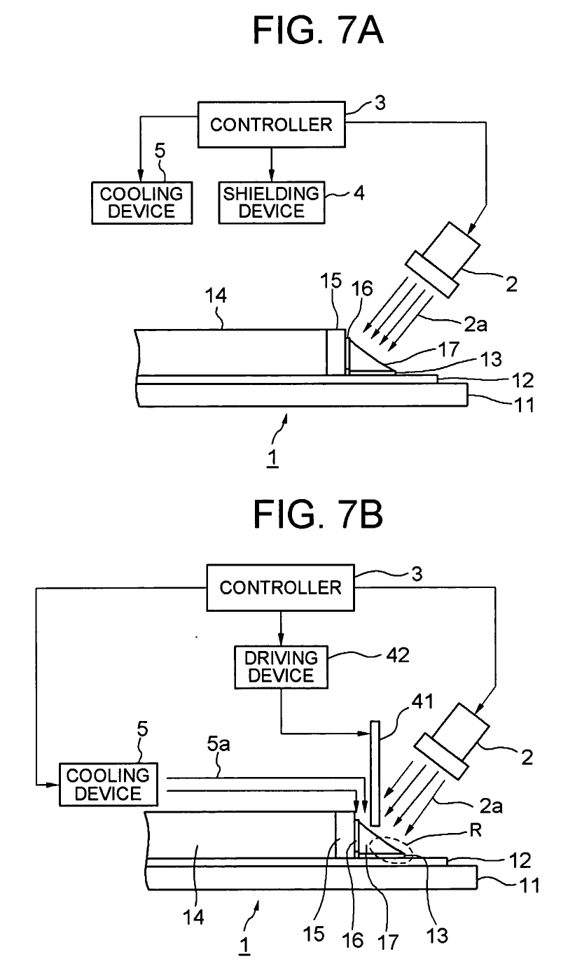

A first embodiment of the present invention will be described by referring to FIG. 3A-FIG. 7B. FIGS. 3A and 3B are schematic views for showing the structure of the soldering apparatus. FIG. 4 is a flowchart for describing operation of the soldering apparatus at the time of soldering. FIGS. 5A-5C are illustrations for schematically showing the states of solder when being heated. FIGS. 6A and 6B are crystallograms that show the state of solder after performing soldering. FIGS. 7A and 7B are schematic views for showing a modification example of the structure of the soldering apparatus.

[Structure]

The soldering apparatus is for manufacturing a magnetic head assembly 1 by solder-bonding a magnetic head slider 14 (an electronic component) and a suspension 11 (a substrate). As shown in FIGS. 3A and 3B, the soldering apparatus comprises a laser torch 2 (heating unit) which outputs a laser beam 2a for heating solder 17, a controller 3 for controlling action of the entire apparatus, a shielding device 4 (a shielding member) for shielding a part of the laser beam 2a, and a cooling device 5 (cooling unit) for cooling the magnetic head slider at the time of heating. In the followings, each structure will be described in detail.

<Soldering Target>

The soldering targets of this embodiment are the magnetic head slider 14 and the suspension 11. Specifically, bonded by using the solder 17 are a solder pad 16 (a slider-side solder pad) that is a connection terminal formed on a magnetic head element part 15 of the magnetic head slider 14 and a solder pad 13 (a substrate-side solder pad) that is a connection terminal formed on a flexible printed circuit 12 that is integrated with the suspension 11. That is, this area becomes a solder junction area. The present invention is particularly effective when bonding the subjects which are disposed almost at right angle, like the above-described both solder pads 13 and 16. The solder used herein is lead-free solder, however, it is not limited to the solder of this kind.

<Laser Torch>

The laser torch 2 is a laser irradiating device for outputting diode laser. Specifically, it comprises a condenser lens of 20 mm diameter with focal points of two types, 18 mm and 54 mm. The wavelength of the outputted laser is 920 nm, and the laser output is 15 mJ. However, the laser irradiating device is not limited to that of the type and property described above.

Irradiating operation of the laser beam 2a by the laser torch 2 is controlled by the controller 3. That is, the controller 3 controls the output value of the laser beam 2a, the irradiation time, the irradiating position, and the like, respectively.

In this embodiment, irradiating state of the laser beam 2a to the solder 17 of each junction area differs for the first time and the second time. Specifically, in the first irradiation, the irradiating position, as shown in FIG. 3A, is set to irradiate roughly between the substrate-side solder pad 13 and the slider-side substrate 16, that is, to irradiate the entire solder junction area. The solder junction area includes at least the solder 17, and may or may not include each of the solder pads 13 and 16 bonded thereto. The output value of the first laser irradiation is higher than that of the second irradiation which will be described later, and the irradiation time is as short as 3-30 mS (0.003-0.03 seconds). The high output value herein is an output value that is capable of applying an amount of heat by which the temperature of the solder 17 can be increased to be melted in the above-described irradiation time.

In the second irradiation, there is no change in the position of the laser torch 2 but the irradiation range is different. The detail will be described later, however, as shown in FIG. 3B, a laser cut cover 41 is disposed by control of the controller 3 so that it is set to irradiate a part of the solder junction area, which is distant form the magnetic head slider 14. Particularly, heat is applied to the vicinity of the junction area (an area shown by reference code R) between the solder 17 and the substrate-side solder pad 13, which is the area most distant from the magnetic head slider 14. The output value at that time is a lower output value than that of the first irradiation, and the irradiation time is 0.5-3 S (seconds). This time is longer than the irradiation time of the first irradiation. The low output value herein is an output value for outputting the laser beam 2a that is capable of heating up to a temperature (around 240°) at which the solder 17 is melted. The irradiating operation by the above-described laser torch 2 may all be controlled by the controller 3 or may be set by operation of an operator.

<Shielding Device>

The shielding device 4 (shielding unit) is constituted with the laser cut cover 41 (shielding member) and a driving device 42 which drive-controls the placing position thereof. The laser cut cover 41 is formed of a plate-type SK material, for example. At the time of performing the second laser irradiation described above, the laser cut cover 41 is driven by the driving device 42 and the end part thereof is disposed at a position for covering over the slider-side solder pad 16 that is formed on the magnetic head element part 15 of the magnetic head slider 14. With this, as shown in FIG. 3B, a part of the laser beam 2a from the laser torch 2 is blocked by the laser cut cover 41, and only the remaining part of the laser beam 2a is to be irradiated to the solder junction area. That is, at the time of the second irradiation, the laser beam 2a is not irradiated to the part of the solder junction area close to the magnetic head element part 15 but only to the part that is distant from the magnetic head element part 15.

Further, as for the positioning of the laser cut cover 41, it is preferable, particularly, to dispose the laser cut cover 41 such that it comes still closer to the magnetic head slider 14 (the magnetic head element part 15) in the vicinity of the solder junction area. Thereby, cooling air 5a outputted from the cooling device 5, which will be described later, can be guided by the laser cut cover 41 to the magnetic head element part 15 and the solder junction area as the heating part. Thus, the cooling effect for the magnetic head element part 15 can be improved.

The form and the material for the laser cut cover 41 is not limited to those described above but may be any materials that can shield the laser beam 2a. It is more desirable to be a material that can reflect the laser beam 2a. Further, it is preferable to adjust the reflectance of the laser beam by coating a prescribed material on the surface, particularly, the part for shielding the laser beam 2a.

<Cooling Device>

The cooling device 5 is a device for outputting cooling air, which is controlled by control of the controller 3 to output the cooling air 5a at the time of the second heating described above. Specifically, it outputs cooling air towards the surface (the opposite surface to the surface where the suspension is mounted) of the magnetic head slider 14 (magnetic head element part 15) and to the magnetic head element part 15. Then, as described above, the outputted cooling air is guided towards the magnetic head slider 14 side by the laser cut cover 41 which is disposed above the magnetic head slider 14 as going towards the solder junction area as the heating part.

[Operation]

Next, operation of the above-described soldering apparatus will be described by referring to a flowchart of FIG. 4. Further, the state of the solder 17 will be described by referring to FIG. 5-FIG. 6.

First, in the state where the magnetic head slider 14 is disposed on the suspension 11 (flexible printed circuit 12), the suspension 11 itself is disposed at a soldering work position of the soldering apparatus. At this time, a solder ball (paste) is disposed in the solder junction area that is the position between the substrate-side solder pad 13 and the slider-side solder pad 16 (step S1).

Subsequently, the controller 3 sets the position of the laser torch 2. Specifically, it is set in a position that is possible to irradiate the laser beam 2a to the entire solder junction area including both of the solder pads 13 and 16 (step S2). Then, the controller 3 controls the output value of the laser beam and the irradiation time so that the high-output laser beam 2a is irradiated for a short time (3-30 mS) over the entire solder junction area (step S3, a first heating step). Since the solder 17 is melted in a short time, soldering can be achieved without having the solder being nonuniformly disposed in either the solder 13 or the solder 16. The state of the solder 17 will be described by referring to a schematic illustration of FIG. 5A. As shown in this drawing, gold on both of the solder pads 13 and 16 is diffused only on a part of the solder 17 in the vicinity of the pad surfaces, thereby producing gold-tin alloy 17a only in that area.

Then, the laser cut cover 41 is disposed at a position shown in FIG. 3B by the controller 3 and the driving device 42 (step S4). Likewise, the cooling device 5 is disposed at a position shown in FIG. 3B by the controller 3 and output of the cooling air 5a is started (step S5). In this state, the controller 3 controls the output value of the laser beam and the irradiation time, and low-output laser beam 2a is irradiated for a long time (0.5-3 S) (step S6, a second heating step). Thereby, a part of the laser beam 2a outputted form the laser torch 2 is blocked by the laser cut cover 41, and the remainder that is a part of the laser beam 2a irradiated from the laser torch 2 is irradiated to the solder junction area. Therefore, the area which is directly heated by the laser beam 2a is the area shown by the reference code R, i.e. the bonded part of the solder 17 and the substrate-side solder pad 13, which is most distant from the magnetic head element part 15.

The state of the solder 17 at the time of the second laser irradiation will be described by referring to a schematic illustration of FIG. 5B. As shown n this drawing, the gold-tin alloy 17a that is formed in the vicinity of the surfaces of the both solder pads 13 and 16 diffuses over the entire solder 17 while the solder 17 is heated by the low-output laser beam 2a. That is, as shown by arrows in the solder 17 of FIG. 5B, the gold in the vicinity of the surface of the substrate-side solder pad 13 diffuses over the entire solder. At the same time, the gold in the vicinity of the surface of the slider-side solder pad 16 diffuses by being drawn to the opposite side that is in the direction of the substrate-side solder pad 13. With this, as shown in FIG. 5C, the gold is diffused over the entire solder 17, thereby producing the gold-tine alloy 17a uniformly.

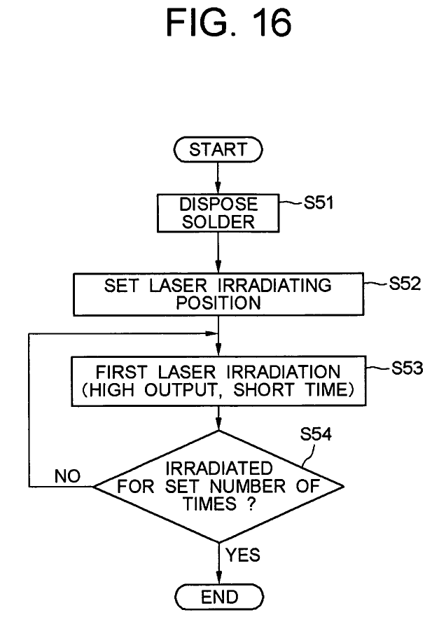

FIG. 6A is a crystallogram of the solder 17 in the above-described soldering. White needle-shape substance therein is the gold-tine alloy, and it can be seen that the tin-gold alloy is diffused uniformly over the entire solder. FIG. 6B is an enlarged picture of the solder 17 in the vicinity of the slider-side solder pad 16. When compared to the conventional case shown in FIGS. 16A and 16B, it can bee seen that the gold-tin alloy is not concentrated in the vicinity of the surface of the solder pad 16 but distributed uniformly.

Thereby, the gold on the solder pads 13 and 16 can be diffused over the entire solder 17. Thus, the gold-tin alloy is distributed uniformly so that the strength of the solder can be improved. Further, at this time, excessive heating of the magnetic head slider 14 (magnetic head element part 15) can be suppressed, thereby enabling to protect the magnetic head slider 14.

The second laser irradiation described above is not limited to irradiate the laser of the lower output value than the output value of the first laser irradiation. Since a part of the output is blocked by the laser cut cover 41, the amount of heat applied to the area R of the solder junction area becomes smaller even though the output value equivalent to that of the first irradiation is outputted in the second time. Therefore, like the above-described case, it is possible to suppress the excessive heating of the magnetic head slider 14.

### Modification Example

Next, a modification example of the soldering apparatus of this embodiment will be described by referring to FIGS. 7A and 7B. FIG. 7A is an illustration for describing the state of the first irradiation, and FIG. 7B is an illustration for describing the state of the second laser irradiation. In the modification example, the basic structure is the same as the above-described structure though the irradiation angle of the laser beam 2a and the position of the placing position of the laser cut cover 41 are different. In the followings, the first irradiation state and the second irradiation state will be separately described.

First, at the time of performing the first irradiation, the laser torch 2 is disposed in the obliquely upper position of the solder junction area as shown in FIG. 7A. From this position, high-output and short-time laser irradiation is performed to the entire solder junction area.

Subsequently, before the second irradiation, the laser cut cover 41 is disposed above the solder junction area so as to be almost vertical to the suspension 11 as shown in FIG. 7B. At this time, the lower-end part of the laser cut cover 41 is disposed at a position adjacent to the center of the solder junction area. Further, like the above-described case, the cooling device 5 is disposed at a position shown in the drawing, and output of the cooling air 5a is started. Thereby, the cooling air 5a comes in contact with the laser cut cover 41 in the vicinity of the magnetic head element part 15 and the solder junction area. Thus, a part of the cooling air 5a goes downward so that the magnetic head element part 15 can be effectively cooled.

In this state, the controller 3 controls the output value of the laser beam and the irradiation time to irradiate the low-output laser beam 2a for a long time. As shown in FIG. 7B, a part of the laser beam 2a outputted from the laser torch 2 is blocked by the lower-end part of the laser cut cover 41 and the remainder is irradiated to the solder junction area. Therefore, the area that is directly heated by the laser beam 2 is the area shown by the reference code R, i.e. the junction area between the solder 17 and the substrate-side solder pad 13, which is most distant from the magnetic head element part 15. With this, like the above-described case, gold of the solder pads 13 and 16 is uniformly diffused over the entire solder 17 while suppressing the excessive heating of the magnetic head slider 14. Thus, it enables to suppress damages to the magnetic head slider and achieve highly reliable soldering.

### Second Embodiment

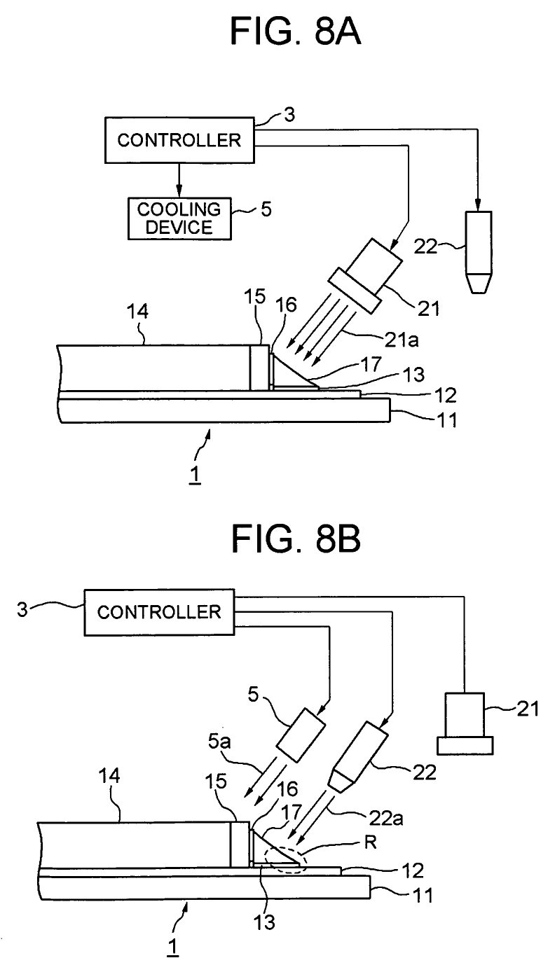

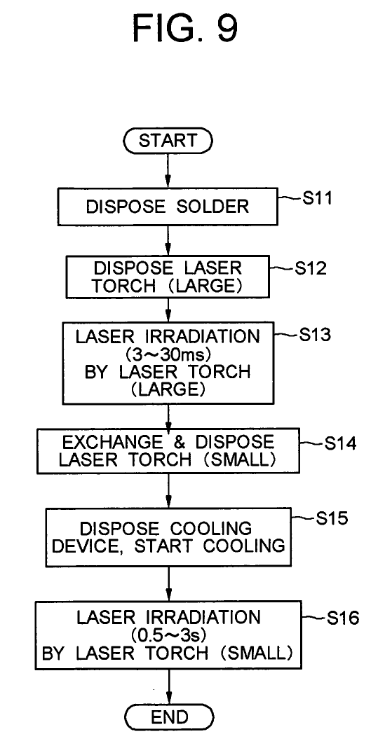

Next, a second embodiment of the present invention will be described by referring to FIG. 8-FIG. 9. FIGS. 8A and 8B are schematic views for showing the structure of the soldering apparatus. FIG. 9 is a flowchart for describing operation of the soldering apparatus at the time of soldering. In the above-described first embodiment, the first heating and the second heating for the solder 17 are performed by the same laser torch 2 (laser irradiating device). However, in the soldering apparatus of the second embodiment, heating of each time is performed by different laser torches 21 and 22, respectively.

[Structure]

As shown in FIG. 8A, the soldering apparatus of the second embodiment comprise a first laser torch 21 (first heating unit) which performs laser irradiation as the first heating to the solder 17 in the solder junction area, and a second laser torch 22 (second heating unit) which performs laser irradiation as the second heating to the solder 17. The first laser torch 21 can irradiate a laser beam 21a over the entire solder junction area as an irradiation range, and performs high-output and short-time laser irradiation. Further, the second laser torch 22 is formed to have a small nozzle end so that it is possible to output laser beam of small diameter. With this, it is possible for the second laser torch 22 to irradiate the laser beam locally to the narrower area than that of the above-described first laser torch 21. It performs long-time laser irradiation.

Further, as will be described in the description of operation provided below, the controller 3 has a function of controlling the laser irradiation operations performed by each of the laser torches 21 and 22. Also, it has a function of drive-controlling the positioning of the laser torches 21 and 22 in association with a driving mechanism that is not shown.

[Operation]

The operation of the soldering apparatus with the above-described structure will be described by referring to the flowchart of FIG. 9. First, like the above-described case, solder is disposed in the solder junction area (step S11), and the first laser torch 21 is disposed (step S12) for performing the first heating. Then, high-output laser beam 21a is irradiated for a short time (3-30 mS) to the entire solder junction area (step S13).

Subsequently, the laser torch for irradiating the laser beam is exchanged with the second laser torch 22 and the laser irradiation position is set (step S14). Further, the cooling device 5 is disposed to face towards the magnetic head element part 15 of the magnetic head slider 14 and output of the cooling air 5a is started (step S15). In this state, the second laser torch 22 irradiates low-output laser beam 22a for a long time (0.5-3 S) (step S16). As shown in FIG. 8B, the laser beam 22a outputted from the laser torch 22 is irradiated only to the area shown by the reference code R in the solder junction area. Therefore, like the above-described case, gold of the solder pads 13 and 16 can be diffused over the entire solder so that the strength of the solder can be improved. In addition, excessive heating of the magnetic head slider 14 (magnetic head element part 15) can be suppressed, thereby enabling to protect the magnetic head slider 14.

The laser irradiation by the above-described second laser torch 22 is not limited to be performed by the lower output value than that of the first laser torch 21. It may be the output value that is equivalent to the output value of the first laser torch 21. Therefore, like the above-described case, it is possible even in such a case to suppress the excessive heating of the magnetic head slider 14 since the laser beam 22a is irradiated only to the area R of the solder junction area, which is distant from the magnetic head slider 14.

### Third Embodiment

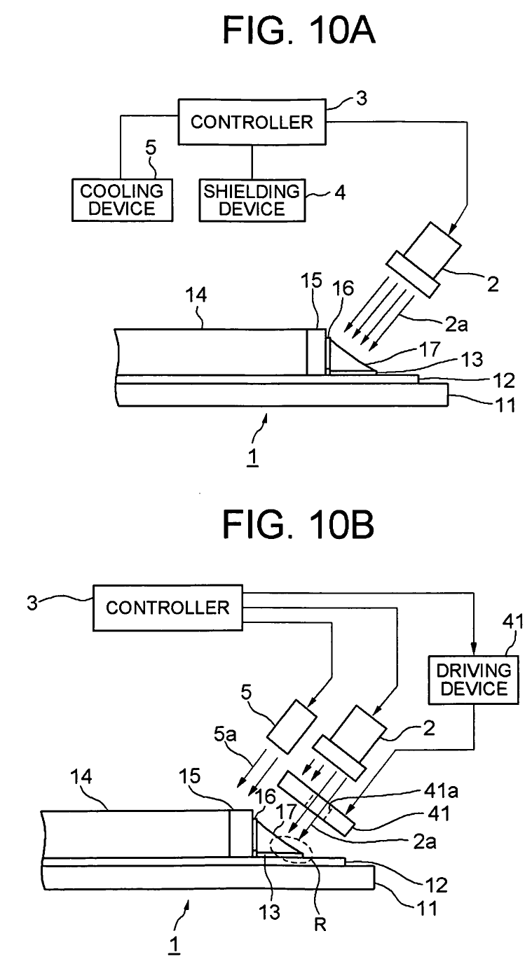

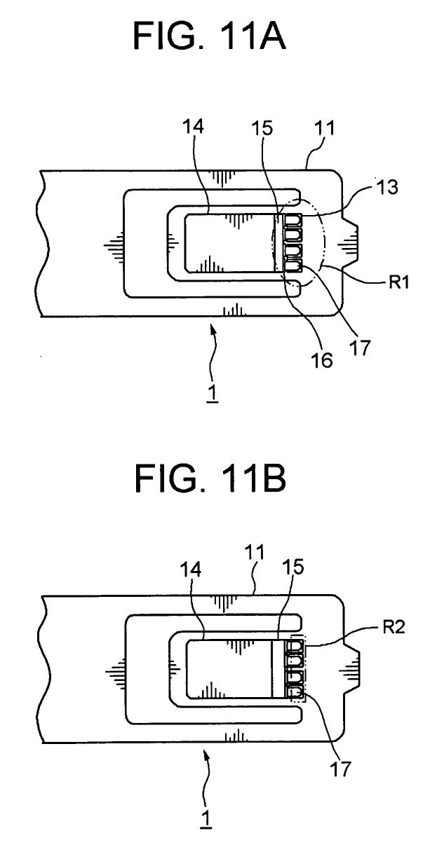

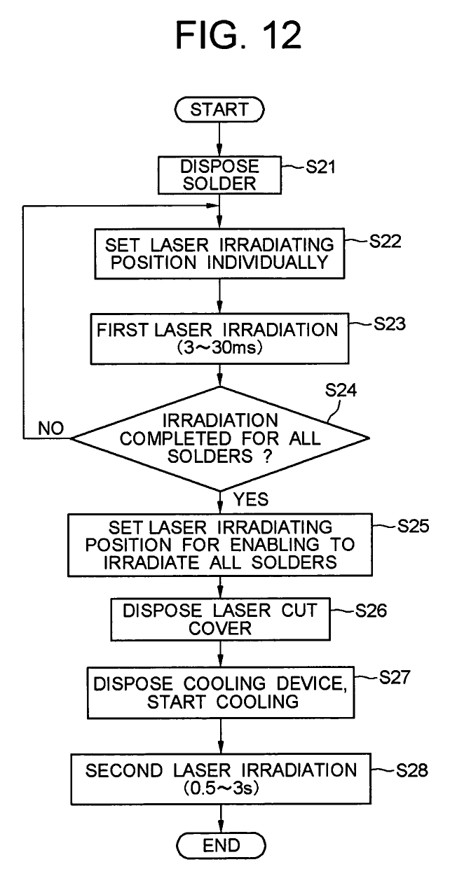

Next, a third embodiment of the present invention will be described by referring to FIG. 10-FIG. 12. FIGS. 10A and 10B are schematic views for showing the structure of the soldering apparatus. FIGS. 11A and 11B are illustrations for describing the laser irradiation range. FIG. 12 is a flowchart for describing the operation of the soldering apparatus at the time of performing soldering. In this embodiment, the shape of the laser cut cover 41 is different form that of the above-described embodiments. Also, it is distinctive from the above-described embodiments in respect that a plurality of solder junction areas are laser-irradiated simultaneously by a single laser torch 2 at the time of second heating. It will be described in detail hereinafter.

[Structure]

First, the laser cut cover 41 of this embodiment is provided with a through hole 41a which lets through a part of the laser beam 2a to the solder junction area. The laser cut cover 41 is used at the second time heating like the above-described case, so that the above-described through hole 41a is formed in a shape that enables to let through the laser beam 2a in the area most distant from the magnetic head element part 15, which is the vicinity of the junction area between solder 17 in all the solder junction areas and the substrate-side solder pad 13. The specific shape will be described later. The position of the laser cut cover 41 is controlled by the controller 3 and the driving device 42 so that the laser can be irradiated to that position.

In this embodiment, particularly, laser irradiation is performed only once in the second heating for dealing with the plurality of solder junction areas. Therefore, first, the irradiation range of the laser beam 2a by the laser torch 2 is set to be wide by including the plurality of solder junction areas as shown by an area R1 of FIG. 11A. Accordingly, output of the laser beam 2a irradiated to the individual solder junction area becomes weak.

The shape of the through hole 41a of the above-described laser cut cover 41 is a shape that shields the range of the laser beam 2a to be irradiated to the above-described area R1 to be still narrower. Specifically, as shown by a reference code R2 of FIG. 11B, it is formed in roughly a rectangular shape so that the laser beam 2a can be let through to the range which includes the junction area between the solder 17 and the substrate-side solder pad 13, which is most distant from the magnetic head element part 15, among the four solder junction areas of the magnetic head assembly 1. That is, the laser beam 2a that has passed through the through hole 41a comes to be in a slit form.

[Operation]

Next, the operation of the above-described soldering apparatus will be described by referring to the flowchart of FIG. 12. First, like the above-described case, the solder 17 is disposed in the solder junction area (step S21). Then, position of the laser torch 2 is set such that the laser beam 2a can be irradiated to the entire solder junction area of a single solder junction area (step S22). Subsequently, high-output laser beam 2a is irradiated for s short time (3-30 mS) (step S23). In this embodiment, there are four solder junction areas. Thus, the first irradiation is individually performed for each of the solder junction areas (after judged as NO in step S24, steps 22 and 23).

After completing the first heating for all the four soldering areas in this manner (YES in step S24), the second heating is performed to all the solder junction areas simultaneously. Thus, the laser irradiation range is set as in the area R1 of FIG. 11A to be able to irradiate the laser beam 2a to all the solder junction areas (step S25). In accordance with this, the laser cut cover 41 is disposed and the position of the through hole 41a is set in such a manner that the laser irradiation range set as the area R1 is shielded to be the area R2 of FIG. 11B (step S26). At the same time, the cooling device 5 is disposed and output of the cooling air 5a is started (step S27).

In this state, the laser beam 2a is irradiated by controlling the irradiation time to be longer (0.5-3 S) while keeping the output value of the laser beam to be the same (step S28). The output value of the laser beam 2a in the second irradiation is the same as that of the first irradiation, however, the amount of heat from the laser beam 2a for each solder junction area decreases since the irradiation range of the laser beam 2a is widened.

Thereby, dispersed laser beam 2a can be irradiated to the solder 17 in all the solder junction areas at once. Thus, like the above-described case, gold of the solder pads 13 and 16 can be diffused over the entire solder 17 so that the strength of the solder can be improved. Further, it can suppress the excessive heating of the magnetic head slider 14 (magnetic head element part 15), thereby enabling to protect the magnetic head slider 14. Moreover, even though there are a plurality of junction areas, the second heating thereof is performed at once. Therefore, the number of times for performing second irradiation can be reduced, thereby achieving simplification and speed-up of the soldering procedure.

The second laser irradiation may be performed individually for each of the plurality of solder junction areas. Accordingly, the shape of the through hole 41a formed on the laser cut cover 41 is not limited to the above-describe shape but may be a circular shape or the like, for example, so as to let through the laser beam 2a to the part of a single solder junction area, which is most distant from the magnetic head slider 14.

### Fourth Embodiment

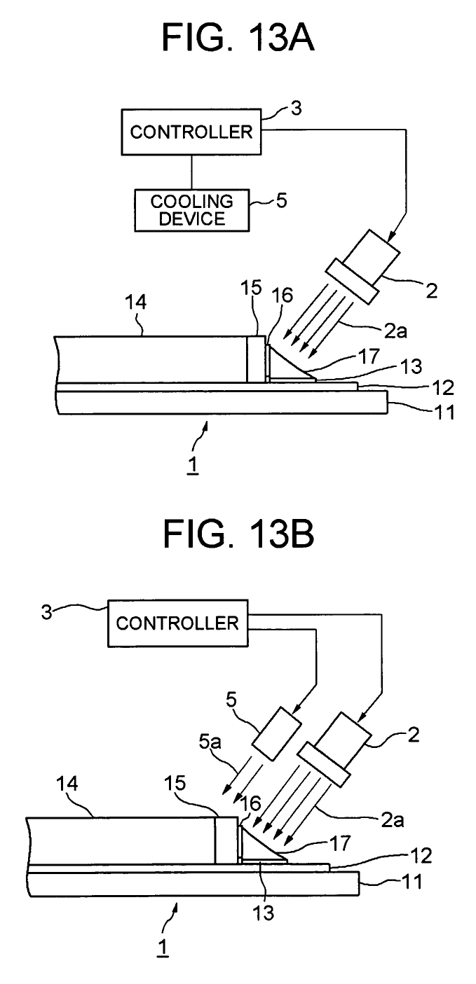

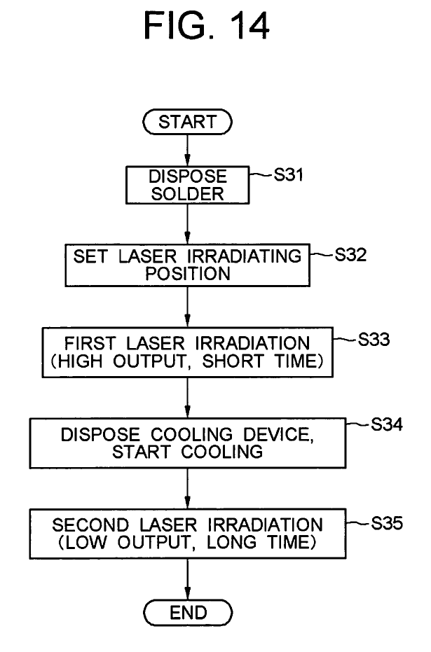

Next, a fourth embodiment of the present invention will be described by referring to FIG. 13A-FIG. 14. FIGS. 13A and 13B are schematic views for showing the structure of the soldering apparatus according to this embodiment. FIG. 14 is a flowchart for describing the operation of the soldering apparatus according to this embodiment at the time of soldering.

Each of the above-described embodiments has been described by referring to the case where a part of the soldering area, which is distant from the electronic component, is heated at the time of the second heating applied to the solder 17. However, this embodiment is distinctive in respect that the second heating is performed for heating the entire solder junction area like the first heating. Accordingly, there is a distinctive feature in a method of performing the second heating.

[Structure]

As shown in FIG. 13A, the soldering apparatus of this embodiment employs almost the same structure as that of the above-described first embodiment. There is no laser cut cover for shielding the laser beam shown in FIG. 13A, however, it may also be mounted.

In this embodiment, particularly, there is a distinctive feature in the irradiating operation of the laser beam 2a by the laser torch 2. As described below, the controller 3 has a function of controlling the action of the laser torch 2. For the first laser irradiation, like the above-described embodiments, the control function controls the action of the laser torch 2 to perform high-output and short-time laser irradiation in order to apply a large amount of heat to the entire solder junction area. For the second irradiation, it controls the action of the laser torch 2 to perform low-output and long-time laser irradiation in order to apply less amount of heat than the first time, while keeping the irradiation range to be the entire solder junction area as in the first time. The above-described control function may be provided to the laser torch 2 itself. Further, the control of the laser irradiation described above may be carried out by a worker without providing the above-described control function to the controller.

Like the above-described embodiments, the cooling device 5 is disposed as shown in FIG. 13B by the control of the controller 3 at the time of second laser irradiation so as to output cooling air towards the surface (opposite surface to the surface where the suspension is mounted) of the magnetic head slider 14 (magnetic head element part 15) and the magnetic head element part 15.

[Operation]

The operation of the soldering apparatus with the above-described structure will be described by referring to the flowchart of FIG. 14. First, like the above-described case, solder is disposed in the solder junction area (step S31), and the first laser torch 21 is disposed for performing the first heating (step S32). At this time, it is disposed in such a manner that the irradiation area of the laser beam 2a covers the entire solder junction area. Then high-output laser beam 2a is irradiated to the entire solder junction area for a short time (step S33). By the heating of the fist laser irradiation, the solder 17 is melted so that bonding between the both solder pads 13, 16 and the solder 17 can be uniformly achieved.

Subsequently, before performing the second laser irradiation, the cooling device 5 is disposed by facing towards the magnetic head element part 15 of the magnetic head slider 14, and output of the cooling air 5a is started (step S34). Then, the second laser irradiation is carried out. In this second laser irradiation, there is no change in position of the laser torch 2 and the laser irradiation range, and the laser beam 2a is irradiated to the entire solder junction area like the first time. However, at this time, the output value of the laser beam 2a is set to a low-output and laser irradiation is performed for a long time (step S35). As described, the output value of the second laser irradiation is low so that the excessive heating of the electronic component can be suppressed. In the meantime, the long-time laser irradiation enables to diffuse the gold of the solder pads 13 and 16 uniformly over the entire solder in the solder junction area.

Thereby, like the above-described embodiments, gold-tin alloy is formed over the entire solder, thereby improving the strength of the solder. Thus, it enables to improve the reliability of soldering and also to protect the magnetic head element part 15 as the electronic component. Moreover, there is no change in the laser irradiation range for the first time and second time, so that it is unnecessary to perform control of the heating position at the time of soldering work. Therefore, it enables to simplify and speed-up the soldering processing.

The second irradiation of the low-output laser beam 2a as described above may be performed thereafter for any number of times. That is, after performing the high-output and short-time first laser irradiation, the low-output laser irradiation may be repeated for any number of times. In that case, the low-output laser irradiation of the second time and after may be performed for a short time in each time.

### Fifth Embodiment

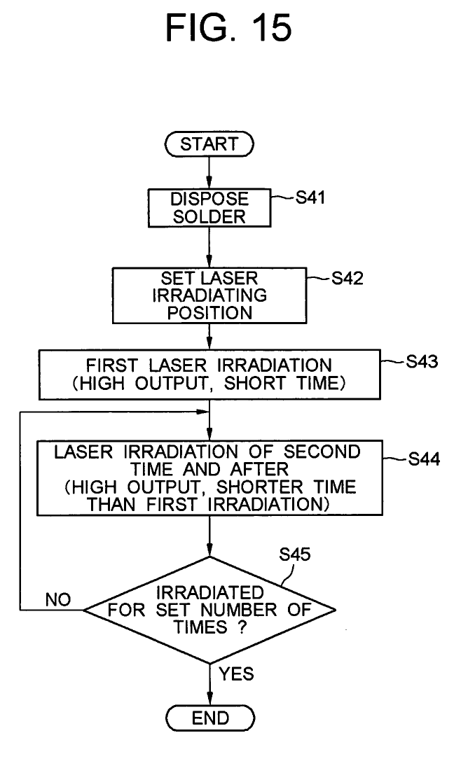

Next, a fifth embodiment of the present invention will be described by referring to FIG. 15 and FIG. 16. FIG. 15 and FIG. 16 are flowcharts for describing the operation of the soldering apparatus according to this embodiment at the time of soldering. This embodiment is distinctive in respect that laser irradiation is intermittently repeated for a plurality of times.

[Structure]

The soldering apparatus of this embodiment is almost the same as that of the above-described fourth embodiment, which employs the structure where there is no change in the laser irradiation range for the first time and second time. That is, the position of the laser torch 2 when irradiating the laser beam 2a is almost the same for the first time, the second time and thereafter.

In this embodiment, particularly, there is a distinctive feature in the irradiating operation of the laser beam 2a by the laser torch 2. As described below, the controller 3 has a function of controlling the action of the laser torch 2. For the first laser irradiation, like the above-described embodiments, the control function controls the action of the laser torch 2 to perform high-output and short-time laser irradiation in order to apply a large amount of heat to the entire solder junction area. For the second irradiation, it controls the action of the laser torch 2 to perform laser irradiation for a still shorter time than the first irradiation in order to apply less amount of heat than the first time, while keeping the output value and the irradiation range to be the entire solder junction area as in the first time. The above-described control function may be provided to the laser torch 2 itself.

[Operation]

The operation of the soldering apparatus with the above-described structure will be described by referring to the flowchart of FIG. 15. First, like the above-described case, solder is disposed in the solder junction area (step S41), and the first laser torch 21 is disposed for performing the first heating (step S42). At this time, it is disposed in such a manner that the irradiation area of the laser beam 2a covers the entire solder junction area. Then high-output laser beam 2a is irradiated to the entire solder junction area for a short time (step S43). By the heating of the first laser irradiation, the solder 17 is melted so that bonding between the both solder pads 13, 16 and the solder 17 can be uniformly achieved.

In the second laser irradiation, there is no change in the position of the laser torch 2 and the laser irradiation range, and the laser beam 2a is irradiated to the entire solder junction area. At this time, the output value of the laser beam 2a is set as it is to be the high-output value without being changed from that of the first time. Then, laser irradiation is performed for a still shorter time than the first time (step S44). Thereafter, the above-described high-output laser irradiation performed for a still shorter time than the first time is repeated for a set number of times (NO in step S45, step S44).

As described above, by repeating the short-time laser irradiation for the second time and after, like the above-described embodiments, the heating thereof enables to diffuse the gold of the solder pads 13 and 16 uniformly over the entire solder 17. Thus, gold-tin alloy is formed over the entire solder 17 so that the strength of the solder can be increased, thereby improving the reliability of soldering. Furthermore, extremely short-time laser irradiation is repeated intermittently for the second time and after. Therefore, it is possible to suppress the excessive heating applied to the electronic component compared to the case of applying the long-time laser irradiation. Thus, the magnetic head element part 15 as the electronic component can be protected. In addition, there is no change in the laser irradiation range and the output value for the laser irradiation of the first time, the second time and after. Therefore, it is unnecessary to perform control of the heating position and the output value at the time of solder work, thereby enabling to achieve simplification and speed-up of the soldering processing.

Like the above-described embodiments, at the time of performing the laser irradiation of the second time and after, the cooling device 5 may be disposed so as to output cooling air towards the surface (opposite surface to the surface where the suspension is mounted) of the magnetic head slider 14 (magnetic head element part 15) and the magnetic head element part 15.

### Modification Example

Now, a modification example of the above-described soldering apparatus and method will be described. In the above, it has been descried that the irradiation time for the first laser irradiation and that of the second time and after are changed. However, in this modification example, there is no difference made between the first time and the second time and after, and laser irradiation is carried out for a plurality of times for the same length of time. That is, in this modification example, the controller 3 has a control function which controls the action of the laser torch 2 so as to perform a plurality of times of high-output and short-time laser irradiation intermittently to the entire solder junction area as the irradiation range. In that case, as the laser torch 2, for example, there is used a laser irradiating device for outputting diode laser, in which the diameter of the condenser lens is 25 mm and the diameter of the nozzle hole is 0.14 mm. The wavelength of the output laser is 1046 nm and the laser output is 26 mJ. At this time, the laser irradiating time is set as 10 mS every time, and it is irradiated intermittently to the solder junction area for four or five times, for example. The operation of this modification example will be described by referring to the flowchart of FIG. 16.

First, like the above-described case, the solder 17 is disposed in the solder junction area (step S51), and the first laser torch 21 is disposed (step S52). At this time, it is disposed in such a manner that the irradiation area of the laser beam 2a covers the entire solder junction area. Then, high-output laser beam 2a is irradiated to the entire solder junction area for a short time (step S53).

Thereafter, irradiation of the laser beam 2a is repeated intermittently until completing the set number of times without changing the setting of the laser irradiation (step S53, step S54). That is, it is controlled to set the irradiation range of the laser beam 2a to bet the entire solder junction area and to output the high-output laser beam 2a for a short time.

By the heating of the first laser irradiation or heating of the laser irradiation performed several times in the beginning, the solder 17 is melted. Thus, bonding between both solder pads 13, 16 and the solder 17 can be performed uniformly. Subsequently, by the repeatedly performed laser irradiation, like the above-described embodiments, the gold-tin alloy is formed over the entire solder 17. Thereby, the strength of the solder is increased and the reliability of soldering can be improved. Further, since the irradiation performed for a plurality of times is carried out intermittently, the excessive heating of the electronic component can be more suppressed than the case of the long-time laser irradiation. Thus, it enables to protect the magnetic head element part 15 as the electronic component. Moreover, the laser irradiation rage, the output value of the laser irradiation, and the irradiation time are not altered for each time of the laser irradiation. Therefore, it is unnecessary to perform control of those values at the time of soldering work, thereby enabling to simplify and speed-up the soldering processing.

### Sixth Embodiment

In all the embodiments described above, the method for disposing the solder 17 to the solder pads 13 and 16 in the beginning is not limited to disposing the solder ball. It may employ a method in which the pre-melted solder 17 is dropped or ejected to be attached to the positions (solder junction area) of the solder pads 13 and 16. Then, the first heating step may be executed to the disposed solder 17.

Further, as described above, in the case where the pre-melted solder 17 is disposed on the solder pads 13 and 16, it may be considered that the above-described first heating step is completed at the point where the melted solder 17 is disposed on the solder pads 13 and 16. In other words, there may be a case where bonding between the solder pads 13 and 16 is achieved by the melted solder 17 so that, thereafter, the second heating step may be executed by disposing the laser cut cover 41 and the cooling device 5. With this, like the above-described case, it is also possible to disperse the gold of the solder pads 13 and 16. Thus, the strength of the solder can be improved.

### Seventh Embodiment

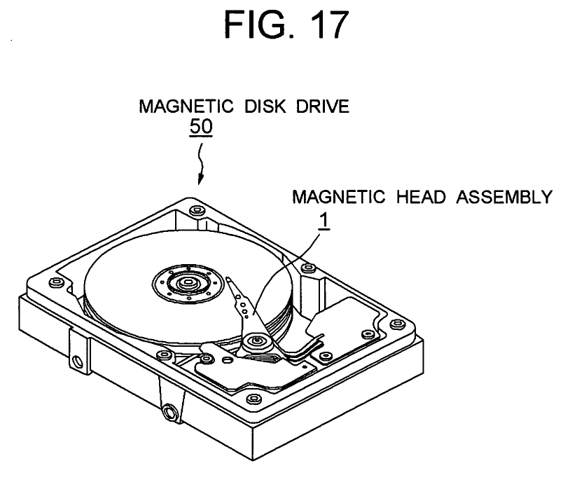

By the soldering performed through the methods illustrated by all the above-described embodiments, the strength of the solder 17 is improved and, in addition, damages to the magnetic head slider 14 caused by heat can be suppressed. Therefore, by manufacturing the magnetic head assembly 1 to which the magnetic head slider 14 is soldered by the above-described method and manufacturing a magnetic disk device 50 (see FIG. 17) to which the magnetic head assembly 1 is mounted, inferiority of the magnetic head slider 14 can be suppressed and the solder bonding becomes highly reliable. As a result, it enables to improve the reliability of the magnetic disk device and the reliability of the product itself of the magnetic head assembly, which constitutes the magnetic disk device.

The soldering apparatus and the method thereof according to the present invention can be used when soldering low heat-resistant electronic components such as a magnetic head slider and the like. Therefore, it exhibits an industrial applicability.

What is claimed is:

1. A soldering method for soldering an electronic component to a substrate, comprising a re-heating step for heating a solder connected area which is distant from said electronic component.

2. A soldering method for soldering an electronic component to a substrate, comprising:
a first heating step for heating entire solder junction area; and
a second heating step for heating a part of said solder junction area, which is distant from said electronic component.

3. The soldering method according to claim 2, wherein said second heating step heats a vicinity of junction area between said solder and said substrate.

4. The soldering method according to claim 2, wherein said second heating step heats a part of said junction area, which is most distant from said electronic component.

5. The soldering method according to claim 2, wherein said second heating step performs heating so as to apply, to said solder junction area, an amount of heat that is smaller than said first heating step.

6. The soldering method according to claim 2, wherein said second heating step performs heating for a longer time than said first heating step.

7. The soldering method according to claim 2, wherein said second heating step performs heating by irradiating a laser beam.

8. The soldering method according to claim 7, wherein said second heating step performs irradiation in such a manner that said laser beam is not irradiated to said electronic component.

9. The soldering method according to claim 7, wherein said second heating step sets an irradiation area by shielding a part of said laser beam.

10. The soldering method according to claim 2, wherein, in said second heating step, said electronic component is cooled.

11. The soldering method according to claim 9, wherein, in said second heating step, a cooling medium is blown against said electronic component and a shielding member used for shielding a part of said laser beam is disposed so that said cooling medium is guided to said electronic component.

12. A soldering method for soldering an electronic component to a substrate, wherein a solder junction area is intermittently heated at least twice or more.

13. The soldering method according to claim 12, wherein each heating of second time and after is performed for a shorter time than first heating.

14. A soldering method for soldering an electronic component to a substrate, wherein:
a solder junction area is intermittently heated at least twice or more; and
each heating of second time and after is performed for a shorter time than first heating.

15. The soldering method according to claim 14, wherein
said heating is performed twice, and second heating is performed for a longer time than said first heating.

16. The soldering method according to claim 1, wherein:
said electronic component is a magnetic head slider; and
said solder junction area is a junction area between said substrate and a connection terminal that is connected to a magnetic head element part of said magnetic head slider.

17. A magnetic head assembly, comprising said magnetic head slider that is bonded to a suspension by said soldering method according to claim 16.

18. The magnetic head assembly according to claim 17, wherein gold is dispersedly present on entire solder of said solder junction area.

19. A magnetic disk device, comprising said magnetic head assembly according to claim 17 being mounted.

20. A soldering apparatus for soldering an electronic component to a substrate, comprising a heating unit for re-heating a solder connected area which is distant from said electronic component.

21. A soldering apparatus for soldering an electronic component to a substrate, comprising:
a first heating unit for heating entire solder junction area; and
a second heating unit for heating a part of said solder junction area of said electronic component that is heated by said first heating unit, which is distant from said electronic component.

22. The soldering apparatus according to claim 21, wherein said first heating unit and said second heating unit are constituted of a same heating unit.

23. The soldering apparatus according to claim 21, wherein said second heating unit performs heating so as to apply, to said solder junction area, an amount of heat that is smaller than said first heating unit.

24. The soldering apparatus according to claim 21, wherein said second heating unit performs heating for a longer time than said first heating unit.

25. The soldering apparatus according to claim 21, comprising a cooling unit for cooling said electronic component when being heated by said second heating unit.

26. The soldering apparatus accruing to claim 21, wherein at least said second heating unit is constituted of a laser irradiating unit which irradiates a laser beam to said solder junction area.

27. The soldering apparatus according to claim 26, wherein said laser irradiating unit as said second heating unit irradiates said laser beam to an area that is smaller than an area of said solder junction area, which is heated by said first heating unit.

28. The soldering apparatus according to claim 26, comprising a shielding member for shielding a part of said laser beam which is irradiated from said laser irradiating unit as said second heating unit.

29. The soldering apparatus according to claim 28, wherein said shielding member comprises a through hole in said solder junction area for letting through a part of said laser beam.

30. A soldering apparatus for soldering an electronic component to a substrate, said apparatus comprising a heating unit which intermittently heats a solder junction area at least twice or more.

31. The soldering apparatus according to claim 30, wherein said heating unit performs each heating of second time and after for a shorter time than first heating.

32. A soldering apparatus for soldering an electronic component to a substrate, comprising a heating unit for heating a solder junction area at least twice or more, wherein
said heating unit performs heating so as to apply an amount of heat that is smaller than first heating when performing heating of second time and after.

33. The soldering apparatus according to claim 32, wherein
said heating unit performs said hating twice, and second heating is performed for a longer time than said first heating.
